(19) United States
(12) Patent Application Publication
(10) Pub. No.: US 2009/0050007 A1
(43) Pub. Date: Feb. 26, 2009

(54) Intaglio plate and method for fabricating the same

(75) Inventors: Akio Fujioka, Tokyo (JP); Nobuhito Ohyama, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignees: SHINEISHA CO., LTD., Tokyo (JP); OHYAMA OPTICAL CORPORATION, Tokyo (JP); GEOMATEC CO., LTD., Yokohama-shi (JP)

(21) Appl. No.: 12/222,409

(22) Filed: Aug. 8, 2008

(30) Foreign Application Priority Data
Aug. 20, 2007 (JP) 2007-213570

(51) Int. Cl. B41N 1/00; B41M 1/10

(52) U.S. Cl. 101/395; 101/170

(57) ABSTRACT

There is provided an intaglio plate 1 excellent in surface strength, in which a pattern of grooves can be formed with a high dimensional accuracy, and further, a scrape hardly occurs, by laminating a binder layer 4 on a surface of a glass base board 2 having grooves 3 therein, and further, laminating a DLC layer on the surface of the binder layer 4.

### BACKGROUND OF THE INVENTION

1. Field of the Invention

The present invention relates to an intaglio plate and a method for fabricating the same.

2. Description of the Related Art

Printing using an intaglio plate (i.e., intaglio printing) has an advantage in forming a relatively fine printing pattern in a substantially uniform thickness and at a reduced cost, and therefore, it has been utilized in not only fabricating a printed matter but also forming a color filter for a liquid crystal display or a circuit board for various types of electronic equipment.

In general, paste such as ink is applied onto a surface of an intaglio plate having grooves formed on a base board in a predetermined pattern, to be filled in the grooves, and then, too much paste squeezed outward of the groove is scraped off by a doctor blade, so that the intaglio printing can be implemented by transferring the paste filled in the grooves formed in the intaglio plate to a matter to be transferred. The intaglio plate for use in the above-described intaglio printing has been exemplified by an intaglio plate having grooves formed on a metallic base board by etching. Here, in a method for etching the metallic base board, the depth of the groove formed is liable to be varied. Even if a pattern having fine grooves is formed with a high dimensional accuracy, there has arisen a problem of a limitation of the fineness and accuracy of the groove on a certain level. This problem becomes more serious as a very fine pattern is more required to be formed with a high dimensional accuracy on a color filter for a liquid crystal display or a circuit board for various types of electronic equipment.

As countermeasures against the above-described problem have been proposed a glass intaglio plate obtained by etching a special glass base board. Such an intaglio plate is adapted to make it difficult to vary the depth of the groove by using a special glass as a base board having grooves formed therein more than in the metallic intaglio plate and to suppress transferring variations with respect to a matter to be transferred, so that a fine groove pattern can be formed with a high dimensional accuracy, as disclosed in Japanese Patent Application Laid-open (JP-A) No. Hei 5-57867.

However, the intaglio plate disclosed in JP-A No. Hei 5-57867 is required to use a special glass having the very high contents of SiO₂ as the base board, thereby inducing a marked increase in fabrication cost, with a possibility of degradation of versatility. In particular, in the case where a flat intaglio plate is used in fabricating a color filter for a liquid crystal display, a large-sized flat intaglio plate is demanded in most cases. In such a case, the demand for the special glass disclosed in JP-A No. Hei 5-57867 induces a very serious problem.

Moreover, the glass intaglio plate disclosed in JP-A No. Hei 5-57867 possibly cannot secure a sufficient surface strength in comparison with the metallic intaglio plate. For example, in scraping the paste by the doctor blade, the tip of the doctor blade collides directly against the side surface of the groove formed in the glass intaglio plate, in particular, the vicinity of a corner at the fore end of the side surface, with a possibility of easy breakage of the groove. In addition, there has been a possibility that a scratch easily occurs on this intaglio plate in scraping the paste by the doctor blade.

In view of this, the present inventors have earnestly studied, and as a consequence, they have found that an intaglio plate excellent in surface hardness can be implemented by using DLC (Diamond Like Carbon), and thus, reached the completion of the present invention.

### SUMMARY OF THE INVENTION

An object of the present invention is to provide an intaglio plate using a glass base board having grooves formed therein, in which a pattern for the grooves can be formed with a high dimensional accuracy, a scratch hardly occurs, and an excellent surface strength can be achieved.

The present invention is featured by (1) an intaglio plate including a binder layer laminated on a surface of a glass base board having grooves formed therein, and a DLC layer laminated on the binder layer; (2) the intaglio plate according to the above item (1), wherein the binder layer is made of metal; and (3) a method for fabricating an intaglio plate including the steps of forming a binder layer on a surface of a glass base board having grooves formed therein in a predetermined pattern, and laminating a DLC layer by sputtering carbon on the binder layer.

The intaglio plate according to the present invention is constituted by forming the binder layer on the surface of the glass base board and further laminating the DLC layer on the binder layer, and therefore, a so-called DLC hybrid intaglio plate is constituted in the point that the DLC layer is superimposed on the glass base board, so that the intaglio plate can be enhanced in surface strength more than an intaglio plate made of only a glass base board. Moreover, the intaglio plate according to the present invention can suppress the breakage of the glass base board since the glass base board can be protected by the DLC layer even if a tip of a doctor blade collides directly against a side surface of the groove formed in the intaglio plate in scraping off paste by the doctor blade. In addition, a scratch hardly occurs on the surface of the intaglio plate in scraping off the paste squeezed out on the surface of the intaglio plate by the doctor blade.

Additionally, the intaglio plate according to the present invention can be fabricated by using a popular glass such as soda lime. In addition, a DLC film can be formed with respect to a large-sized glass base board, so that a large-sized flat intaglio plate can be readily fabricated according to the present invention.

With the intaglio plate according to the present invention, the DLC layer is laminated on the glass base board having the binder layer formed thereon, thus suppressing a peeling possibility of the DLC layer from the intaglio plate. Moreover, with the intaglio plate according to the present invention, the binder layer is interposed between the glass base board and the DLC layer, so that the binder layer can alleviate an action of an inside stress of the DLC layer with respect to the glass base board. As a consequence, it is possible to produce an effect of reducing a possibility of large flexure on the glass base board due to the inside stress of the DLC layer. This effect is prominent in the case of, in particular, a flat intaglio plate.

With the intaglio plate according to the present invention, the DLC layer is formed at an outermost surface, and therefore, the intaglio plate can be low in surface friction coefficient in comparison with an intaglio plate having a metallic layer formed at an outermost surface. As a consequence, the tip of the doctor blade can be more smoothly moved on the intaglio plate in scraping off the paste by the doctor blade.

With the method for fabricating the intaglio plate according to the present invention, it is possible to fabricate the intaglio plate excellent in surface strength more than an intaglio plate made of only the glass base board.

With the method for fabricating the intaglio plate according to the present invention, a boundary between a side surface defining the groove and the surface of the intaglio plate (a surface except the groove) is formed into a little R-shape when the DLC layer is laminated on the glass base board, thus effectively suppressing the breakage of the glass base board at the time of the collision of the tip of the doctor blade.

With the method for fabricating the intaglio plate according to the present invention, the DLC layer can be formed in a substantially uniform thickness, so that it is possible to obtain the intaglio plate having the enhanced surface strength while maintaining the high dimensional accuracy. Moreover, with the method for fabricating the intaglio plate according to the present invention, it is possible to effectively suppress the occurrence of numerous unevennesses in a longitudinal direction of the groove (i.e., along a ridge line) on the boundary defined on the obtained intaglio plate, thus achieving the intaglio plate having the groove of the high dimensional accuracy.

Additionally, with the method for fabricating the intaglio plate according to the present invention, the pattern for the grooves is formed directly on the glass base board normally used as an original plate in fabricating the intaglio plate, and then, the original plate per se can be used as the intaglio plate. As a consequence, it is possible to obtain the intaglio plate more excellent in dimensional accuracy of the groove.

### BRIEF DESCRIPTION OF THE DRAWINGS

FIG. 1 is a cross-sectional view showing an intaglio plate in an embodiment according to the present invention;

FIG. 2A is a cross-sectional view showing an example of blanks which can be used in fabricating the intaglio plate according to the present invention; FIG. 2B is a cross-sectional view showing an example of photomask blanks which can be used in fabricating the intaglio plate according to the present invention; FIG. 2C is a cross-sectional view illustrating a state in which grooves are formed on a resist film during the fabrication of the intaglio plate according to the present invention; and FIG. 2D is a cross-sectional view illustrating a state in which grooves are formed on a metallic thin film during the fabrication of the intaglio plate according to the present invention; and

FIG. 3A is a cross-sectional view illustrating a state in which grooves are formed on a glass base board during the fabrication of the intaglio plate according to the present invention; FIG. 3B is another cross-sectional view illustrating the state in which the grooves are formed on the glass base board during the fabrication of the intaglio plate according to the present invention; and FIG. 3C is a cross-sectional view illustrating a state in which a binder layer is formed on the glass base board during the fabrication of the intaglio plate according to the present invention.

### DESCRIPTION OF THE PREFERRED EMBODIMENTS

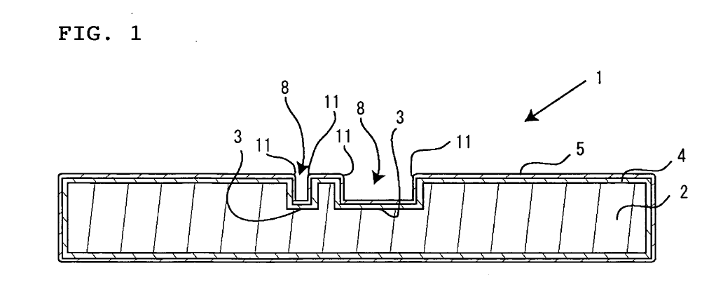

As shown in FIG. 1, an intaglio plate 1 according to the present invention is formed by laminating a binder layer 4 on a surface of a glass base board 2 having grooves 3 therein, and further, laminating a DLC (Diamond Like Carbon) layer 5 on the surface of the binder layer 4. In the intaglio plate 1, a recess 8 is formed by laminating the binder layer 4 and the metal-plating layer 5 in this order in the groove 3 in the glass base board 2, in which a boundary position (i.e., a boundary 11) between a surface except the recess 8 and a side surface of the recess 8 in the intaglio plate 1 is formed into a little R-shape.

A pattern, a dimension and the like such as a depth and a width of the recess 8 in the intaglio plate 1 is not particularly limited. Furthermore, a pattern, a dimension and the like such as a depth and a width of the groove 3 constituting the recess 8 is not particularly limited as long as the groove 3 can be formed on the glass base board 2, and therefore, it may be appropriately set.

Glass for use in the glass base board 2 may be arbitrarily selected from various kinds of glass such as silica glass, borosilicate glass, soda lime, low alkali glass and non-alkali glass.

The binder layer 4 has an adhesiveness to the glass base board 2 and an adhesiveness to the DLC layer 5 stronger than that between the DLC layer 5 and the glass base board 2. Moreover, the binder layer 4 has an inside stress smaller than that of the DLC layer 5. The above-described binder layer 4 is a layer made of metal such as titanium, tungsten, chromium, aluminum or an alloy thereof, or may be a ceramics layer made of silicon carbide, tungsten carbide, titanium carbide, aluminum nitride, silicon nitride, titanium nitride, chromium nitride, calcium oxide, alumina or a mixture of two kinds or more thereof. Here, the binder layer 4 is preferably made of the metal from the viewpoint of the adhesiveness to both of the glass base board 2 and the DLC layer 5.

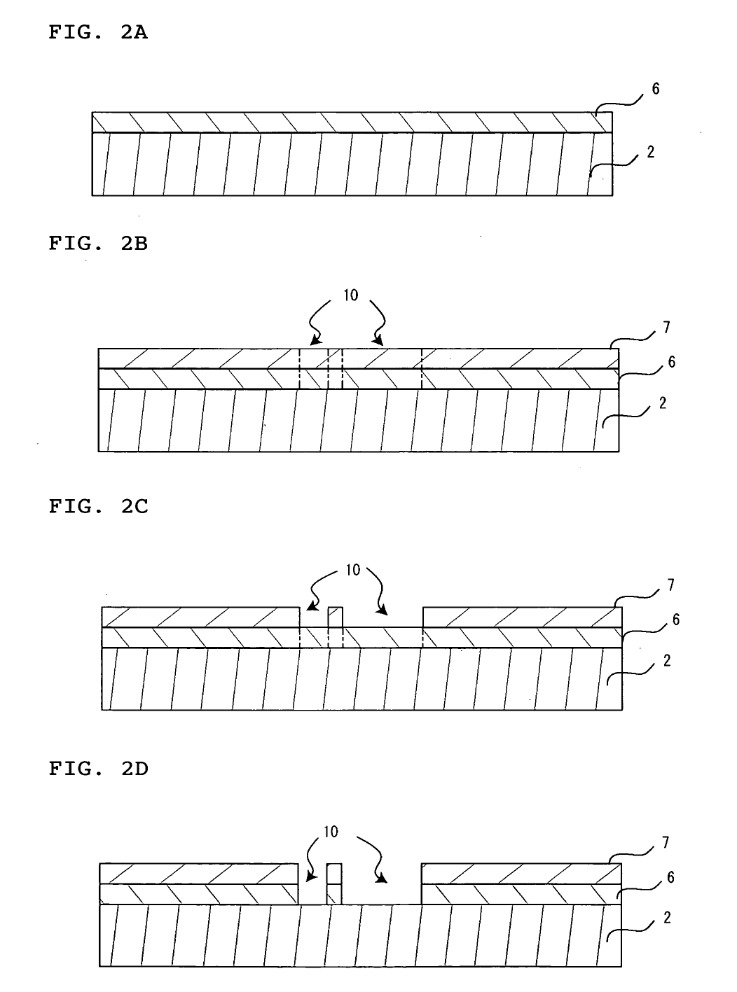

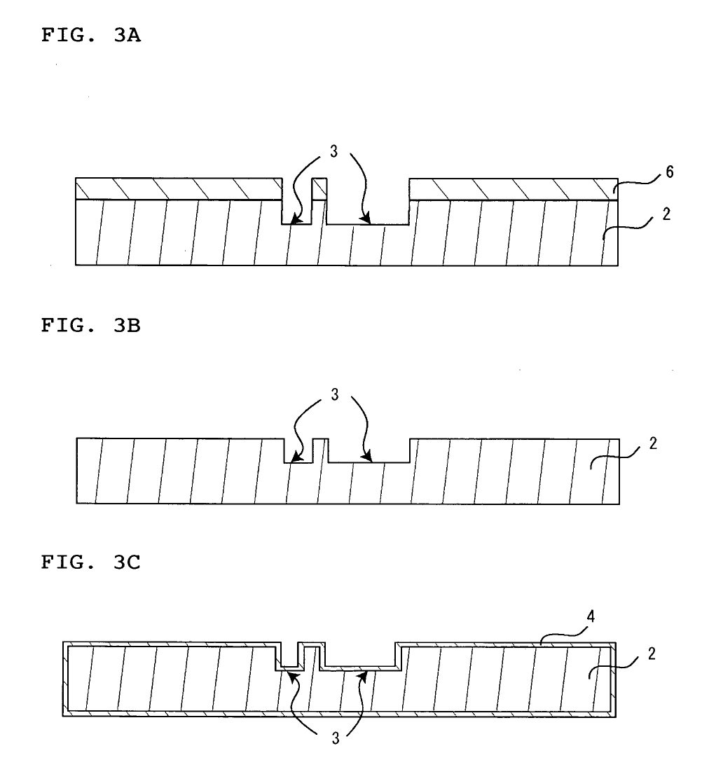

The intaglio plate 1 according to the present invention is fabricated, as follows (FIG. 2 and FIG. 3).

First of all, the glass base board 2 having the grooves 3 formed therein in a predetermined pattern is produced. The groove 3 may be formed in the glass base board 2 by appropriately using a known method such as a method with a photoresist.

In the case where the groove 3 is formed in the glass base board 2 by using a photoresist, the glass base board 2 having the grooves 3 formed therein can be obtained, for example, as follows: with a blanks obtained by forming a metallic thin film 6 made of chromium or the like on a glass material serving as a base of the glass base board 2 (FIG. 2A), a photomask blanks is obtained by forming a resist film 7, and the resist film 7 is formed by applying a resist onto the metallic thin film 6 of the blanks (FIG. 2B). A portion corresponding to a forming position of the groove 3 in the predetermined pattern (a groove corresponding portion 10) on the photomask blanks (i.e., on the resist film 7) is irradiated with a light beam by a laser beam plotter, so that the groove corresponding portion 10 and the other portions are made different in property from each other. The resist film 7 is removed from the groove corresponding portion 10 based on the difference in property, and then, the surface of the metallic thin film 6 is exposed (FIG. 2C). The surface of the glass base board 2 is exposed by etching the metal constituting the metallic thin film 6 at a portion at which the surface of the metallic thin film 6 is exposed (FIG. 2D), thereby etching the glass at the portion at which the glass base board 2 is exposed (FIG. 3A). In this manner, the groove 3 can be formed in the glass base board 2 in the predetermined pattern (FIG. 3B).

The resist film 7 except the groove corresponding portion 10 is removed after the metal constituting the metallic thin film 6 is etched and before or after the glass is etched. The resist film 7 can be removed by appropriately using a known method.

Incidentally, the metallic thin film 6 is formed by appropriately using a known method such as vapor deposition. A method for etching the metal constituting the metallic thin film 6 can be appropriately selected from known methods such as a drying method and a wetting method.

Furthermore, a known method such as the drying method and the wetting method can be appropriately used as a glass etching method. In general, in etching the glass, there hardly occur variations in etching amount notwithstanding positions to be etched, better than the metal etching, and as a result, variations hardly occur in the depth of the groove 3 to be formed. Therefore, the groove 3 can be etched with a high accuracy, so that the pattern of the grooves 3 can be formed on the glass base board 2 with a high dimensional accuracy.

Next, the binder layer 4 is laminated on the glass base board 2 having the grooves 3 formed therein (FIG. 3C). The thickness of the binder layer 4 to be formed is appropriately set according to the depth and width of the groove 3, the thickness of the glass base board 2, the thickness of the DLC layer 5 or the like.

The binder layer 4 can be appropriately formed by a normal method. Specifically, the binder layer 4 may be formed by, for example, sputtering a component of the binder layer 4 onto the glass base board 2. The sputtering may be carried out by appropriately selecting conditions by the use of a known sputtering device, as described below.

A sputtering device is normally configured such that a rotatable supporter for supporting the glass base board 2 and a holder for holding a sputtering target disposed opposite to a predetermined surface on the glass base board 2 are housed in a vacuum chamber, the vacuum chamber including a gas introducing port, through which a predetermined gas such as argon gas is introduced, and an exhaust port, through which the gas staying in the vacuum chamber is exhausted.

The binder layer 4 is formed by the sputtering, as follows: first of all, the glass base board 2 is put on the supporter in the sputtering device, and then, the component constituting the binder layer 4 is used as the sputtering target, to be disposed in the holder. Subsequently, a pressure inside of the vacuum chamber is reduced by degassing the gas staying in the vacuum chamber through the exhaust port while the predetermined gas such as the argon gas is introduced through the gas introducing port in the vacuum chamber. And then, the gas introduced into the vacuum chamber is ionized by plasma. Inside of the vacuum chamber, the ionized gas collides against the sputtering target, which is then sputtered. Sputtered particles are deposition particles which adhere onto the surface of the glass base board 2. At this time, the deposition particles of the sputtering target may adhere to the side surface of the groove 3 in the glass base board 2. In this manner, the binder layer 4 is formed on the glass base board 2.

Thereafter, the DLC layer 5 is laminated on the exposed surface (i.e., an air interface) of the binder layer 4 laminated on the glass base board 2 (FIG. 1).

The thickness of the DLC layer 5 is appropriately selected according to the width and depth of the recess 8 formed in the intaglio plate 1 and the dimensional accuracy required for the width and depth of the recess 8 formed in the intaglio plate 1 to an extent enough not to utterly embed the recess 8 formed in the intaglio plate 1.

The DLC layer 5 may be laminated on the binder layer 4 formed on the glass base board 2 by sputtering carbon, or by depositing carbon onto the glass base board 2 by the use of a CVD (Chemical Vapor Deposition) method.

In the case where the DLC layer 5 is formed by sputtering carbon, the DLC layer 5 may be appropriately formed under known conditions by the use of a known sputtering device.

For example, the device having the configuration which has been described in forming the binder layer 4 may be used as the sputtering device in forming the DLC layer 5.

The DLC layer 5 is formed by the sputtering by the use of the sputtering device, as follows: first of all, the glass base board 2 having the binder layer 4 laminated thereon is disposed in the supporter in the sputtering device while carbon serving as the sputtering target is disposed in the holder. Subsequently, like in forming the binder layer 4, the gas staying in the vacuum chamber is degassed through the exhaust port while the predetermined gas such as argon gas is introduced through the gas introducing port in the vacuum chamber. And then, the gas is ionized by plasma. The ionized gas collides against the sputtering target, which is then sputtered. Sputtered particles are deposition particles which adhere onto the surface of the binder layer 4 on the glass base board 2. At this time, the deposition particles of the sputtering target may adhere to also the binder layer 4 formed at the side surface of the groove 3 formed in the glass base board 2. In this manner, the DLC layer 5 is laminated on the surface of the binder layer 4 formed on the glass base board 2.

In the case where the DLC layer 5 is formed by the CVD method, the DLC layer 5 may be formed under predetermined carrying-out conditions (such as a vacancy inside of the vacuum chamber, a temperature, the kind of raw material gas and the like) by using the normal method by the use of the device used in the known CVD method. Moreover, in the case where the DLC layer 5 is formed by the CVD method, a plasma CVD method is preferable, and further, a high-frequency plasma CVD method is more preferable from the viewpoint of the enhancement of the adhesiveness of the DLC layer 5.

In the case of the formation of the DLC layer 5 by the CVD method, a raw material gas as a carbon source constituting the DLC layer 5 may be selected from gas of a hydrocarbon compound such as methane, acetylene or benzene.

In the above-described manner, the intaglio plate 1 can be obtained in which the binder layer 4 and the DLC layer 5 are laminated in this order on the glass base board 2 and the recess 8 is formed while forming the boundary 11 into a little R-shape.

Incidentally, in the intaglio plate 1 according to the present invention, the description has been given of the case where the binder layer 4 is formed at the entire surface of the glass base board 2 (inclusive of the grooves 3), and further, the DLC layer 5 is formed in such a manner as to cover the entire exposed surface of the binder layer 4 inclusive of the grooves 3 (FIG. 1). However, the binder layer 4 and the DLC layer 5 may be formed at a part of the surface of the glass base board 2, and the DLC layer 5 may be laminated at a part of the binder layer 4. For example, in the intaglio plate 1, taking two surfaces in inverse relationship with each other in the thickness direction of the glass base board 2, that is, a surface at which the groove 3 is formed (a groove forming surface) and a surface at which no groove 3 is formed, into consideration, the binder layer 4 and the DLC layer 5 may be formed in this order only at the groove forming surface. The above-described intaglio plate 1 is excellent in surface strength more than an intaglio plate constituted of only the glass base board from the viewpoint of reduction of a possibility of a breakage occurring in contact with a doctor blade.

What is claimed is:

1. An intaglio plate comprising:
a binder layer laminated on a surface of a glass base board having grooves formed therein; and
a DLC layer laminated on the surface of the binder layer.

2. The intaglio plate according to claim 1, wherein the binder layer is made of metal.

3. A method for fabricating an intaglio plate comprising the steps of:
forming a binder layer on a surface of a glass base board having grooves formed therein in a predetermined pattern; and
laminating a DLC layer by sputtering carbon on the binder layer.
